(19) United States
(12) Patent Application Publication
(10) Pub. No.: US 2018/0188057 A1
(43) Pub. Date: Jul. 5, 2018

(54) DETECTING AND SIMULATING A MOVING EVENT FOR AN AFFECTED VEHICLE

(71) Applicant: International Business Machines Corporation, Armonk, NY (US)

(72) Inventors: Mari Abe Fukuda, Tokyo (JP); Kaoru Hosokawa, Tokyo (JP); Satoshi Hosokawa, Tokyo (JP); Yasutaka Nishimura, Kanagawa-ken (JP); Makoto Tanibayashi, Tokyo (JP); Takahito Tashiro, Tokyo (JP); Shoichiro Watanabe, Tokyo (JP)

(21) Appl. No.: 15/396,973

(22) Filed: Jan. 3, 2017

(51) Int. Cl. G01C 21/36; G01C 21/20

(52) U.S. Cl. CPC G01C 21/3617; G01C 21/3655; G01C 21/20

(57) ABSTRACT

Event data for at least one moving event is received. From the event data, moving event data indicating a trend of the moving event can be generated. For each of a plurality of vehicles, historical trip pattern data can be accessed and, based on the historical trip pattern data, a probability that the vehicle will be affected by the moving event can be determined. A moving event simulation can be generated based on, at least in part, the historical pattern data and the trend of the moving event. The moving event simulation can predict future locations of the vehicle and the moving event at each of a plurality of future time intervals. Based on the moving event simulation, a determination can be made as to when the vehicle will be affected by the moving event. A notification regarding the moving event can be communicated.

### BACKGROUND

The present invention relates to data processing systems, and more specifically, to navigation systems.

Many automobile drivers find navigation systems more convenient to use than traditional maps, and navigation systems have largely displaced the use of traditional maps. Navigation systems represent a convergence of a number of diverse technologies, including database technologies and global positioning systems (GPSs). Navigation systems typically use a road database in which street names or numbers and street addresses are encoded as geographic coordinates. The navigation systems can receive GPS coordinates for a particular automobile and, using the road database, determine directions a driver should navigate from a current location to arrive at a desired destination. The directions may be presented to the user, for example via a dedicated navigation unit, a smart phone or a tablet computer, to guide the user to the desired destination. In some cases, the directions may be provided to an autonomous vehicle, and the autonomous vehicle can follow the directions to arrive at a desired destination.

Currently, navigation systems sometimes notify drivers of traffic congestion that may cause travel delays on certain roadways. These current systems, however, do not consider trends for the events, and do not know which vehicles actually will be impacted by the traffic congestion. For example, if traffic congestion is starting to lessen, vehicles that are still far from the traffic congestion may not be impacted by the traffic congestion. Nonetheless, drivers of those vehicles may choose alternate routes to avoid the traffic congestion, even though they need not do so; the traffic congestion may clear by the time the vehicles reach the location where the traffic congestion occurred.

### SUMMARY

A method includes receiving event data for at least one moving event. From the event data, moving event data can be generated for the moving event. The moving event data can indicate a trend of the moving event. The method also can include storing the moving event data to a functional data structure. The method also can include, for each of a plurality of vehicles, accessing historical trip pattern data for the vehicle and, based on the historical trip pattern data, determining a probability that the vehicle will be affected by the moving event. The method also can include, for each of a plurality of vehicles, generating, using a processor, a moving event simulation based on, at least in part, the historical pattern data for the vehicle and the trend of the moving event, the moving event simulation predicting a future location of the vehicle and a future location of the moving event at each of a plurality of future time intervals. The method also can include, for each of a plurality of vehicles, based on the moving event simulation, determining when the vehicle will be affected by the at least one moving event if the vehicle travels a route intersecting the moving event. The method also can include, for each of a plurality of vehicles, responsive to the determining that the probability that the vehicle will be affected by the moving event exceeds a threshold value, communicating to a client device associated with the vehicle a notification indicating the at least one moving event and a time when the vehicle will be affected by the at least one moving event.

Accordingly, the drivers of the vehicles can be notified not only of the event, but when the drivers may actually be impacted by the moving event. In this regard, the historical pattern data for each vehicle can be used to generate a time-distance data array for each vehicle and, for each vehicle, the time-distance data array can be processed with the trend of the moving event to generate the moving event simulation. The time-distance data array can indicate amounts of time for the vehicle to travel various distances. The amounts of time for the vehicle to travel various distances can be based on, at least in part, at least one other event that is located between the vehicle and the moving event.

In one arrangement, generating moving event data for the moving event can include determining whether a time stamp for the event data is within a threshold period of time of an existing event data and, responsive to determining that the time stamp for the event data is within the threshold period of time of an existing event data pertaining to the moving event, creating a pairwise combination of the event data and the existing event data in the functional data structure. This can facilitate identifying trends for the moving event.

A system includes a processor programmed to initiate executable operations. The executable operations include receiving event data for at least one moving event. From the event data, moving event data can be generated for the moving event. The moving event data can indicate a trend of the moving event. The executable operations also can include storing the moving event data to a functional data structure. The executable operations also can include, for each of a plurality of vehicles, accessing historical trip pattern data for the vehicle and, based on the historical trip pattern data, determining a probability that the vehicle will be affected by the moving event. The executable operations also can include, for each of a plurality of vehicles, generating a moving event simulation based on, at least in part, the historical pattern data for the vehicle and the trend of the moving event, the moving event simulation predicting a future location of the vehicle and a future location of the moving event at each of a plurality of future time intervals. The executable operations also can include, for each of a plurality of vehicles, based on the moving event simulation, determining when the vehicle will be affected by the at least one moving event if the vehicle travels a route intersecting the moving event. The executable operations also can include, for each of a plurality of vehicles, responsive to the determining that the probability that the vehicle will be affected by the moving event exceeds a threshold value, communicating to a client device associated with the vehicle a notification indicating the at least one moving event and a time when the vehicle will be affected by the at least one moving event.

A computer program product includes a computer readable storage medium having program code stored thereon. The program code is executable by a processor to perform a method. The method includes receiving, by the processor, event data for at least one moving event. From the event data, moving event data can be generated, by the processor, for the moving event. The moving event data can indicate a trend of the moving event. The method also can include storing, by the processor, the moving event data to a functional data structure. The method also can include, for each of a plurality of vehicles, accessing, by the processor, historical trip pattern data for the vehicle and, based on the historical trip pattern data, determining a probability that the vehicle will be affected by the moving event. The method also can include, for each of a plurality of vehicles, generating, by the processor, a moving event simulation based on, at least in part, the historical pattern data for the vehicle and the trend of the moving event, the moving event simulation predicting a future location of the vehicle and a future location of the moving event at each of a plurality of future time intervals. The method also can include, for each of a plurality of vehicles, based on the moving event simulation, determining, by the processor, when the vehicle will be affected by the at least one moving event if the vehicle travels a route intersecting the moving event. The method also can include, for each of a plurality of vehicles, responsive to the determining that the probability that the vehicle will be affected by the moving event exceeds a threshold value, communicating, by the processor, to a client device associated with the vehicle a notification indicating the at least one moving event and a time when the vehicle will be affected by the at least one moving event.

### BRIEF DESCRIPTION OF THE DRAWINGS

FIG. 1 is a block diagram illustrating an example of a network data processing environment.

FIG. 2 illustrates a table indicating examples of events and corresponding cause codes.

FIG. 3 illustrates a table indicating examples of event data received by a navigation service.

FIG. 4 illustrates a table indicating examples of event data stored to a functional data structure.

FIG. 5 is a flow chart illustrating an example of a method of maintaining event data in a functional data structure.

FIG. 6 is a diagram depicting an example of a road network, affected by an event, on which vehicles are traveling.

FIG. 7 illustrates a table indicating examples of probabilities each vehicle will be affected by an event, and when and where the vehicle will be affected.

FIG. 8 is a flow chart illustrating an example of a method of generating a moving event simulation to determine when a vehicle will be affected by a moving event.

FIG. 9 is a block diagram illustrating example architecture for a navigation server 110.

### DETAILED DESCRIPTION

This disclosure relates to data processing systems, and more specifically, to navigation systems. In accordance with the inventive arrangements disclosed herein, a navigation service can identify events, including moving events. The navigation service can, for each moving event, identify a trend of the moving event, for example a heading and velocity in which the event is moving. The navigation service also can process historical trip pattern data for a plurality of vehicles and/or drivers. Based on the historical trip pattern data, the navigation service can determine a probability, for each of the vehicles, that the travel of the vehicle will be affected by the moving event. Further, based on the trend of the moving event and the historical trip pattern data, as well as other events that may be present between the moving event and the vehicles, the navigation service can determine when and/or where each of the vehicles will be affected by the moving event. For example, the navigation service can determine when and/or where travel of each of the vehicles will intersect movement of the moving event. For each vehicle, if the probability that the travel of the vehicle will be affected by the moving event exceeds a threshold value, the navigation service can communicate to the vehicle (or the driver of the vehicle) a notification indicating the moving event and when and/or where the vehicle will be affected by the moving event.

Several definitions that apply throughout this document now will be presented.

As defined herein, the term “event” means an occurrence that affects flow of traffic on a roadway.

As defined herein, the term “moving event” means an event that moves or expands over time.

As defined herein, the term “client device” means a processing system including at least one processor and memory that requests navigation services from a server. Examples of a client device include, but are not limited to, a navigation unit or system, a tablet computer, a smart phone, a personal digital assistant, a smart watch, smart glasses, and the like. Network infrastructure, such as routers, firewalls, switches, access points and the like, are not client devices as the term “client device” is defined herein.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “computer readable storage medium” means a storage medium that contains or stores program code for use by or in connection with an instruction execution system, apparatus, or device. As defined herein, a “computer readable storage medium” is not a transitory, propagating signal per se.

As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “real time” means a level of processing responsiveness that a user or system senses as sufficiently immediate for a particular process or determination to be made, or that enables the processor to keep up with some external process.

As defined herein, the term “output” means storing in memory elements, writing to display or other peripheral output device, sending or transmitting to another system, exporting, or similar operations.

As defined herein, the term “driver” means a person (i.e., a human being) driving a vehicle or a processing system configured to automatically drive a vehicle.

As defined herein, the term “automatically” means without user intervention.

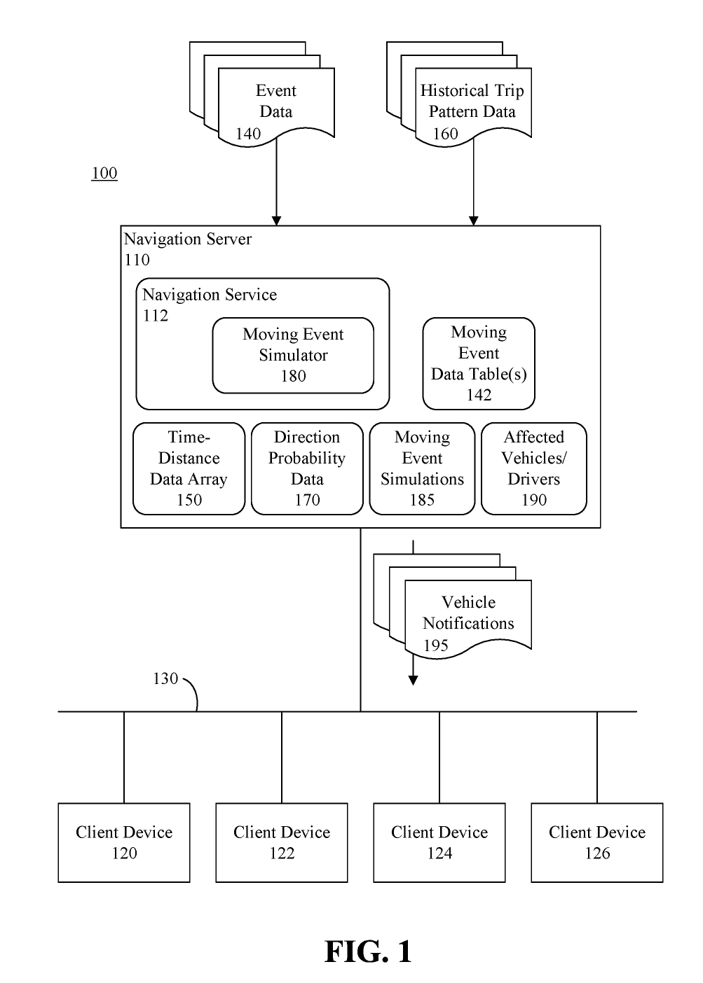

FIG. 1 is a block diagram illustrating an example of a computing environment 100. The computing environment 100 can include a navigation server 110 hosting a navigation service 112. The computing environment 100 also can include a plurality of client devices 120, 122, 124, 126. Each of the navigation server 110 and client devices 120-126 can include at least one processor and memory. The client devices 120-126 can communicatively link to the navigation server 110 via at least one communication network 130. The communication network 130 is the medium used to provide communications links between various devices and data processing systems connected together within the computing environment 100. The communication network 130 may include connections, such as wire, wireless communication links, or fiber optic cables. The communication network 130 can be implemented as, or include, any of a variety of different communication technologies such as a WAN, a LAN, a wireless network, a mobile network, a Virtual Private Network (VPN), the Internet, the Public Switched Telephone Network (PSTN), or similar technologies.

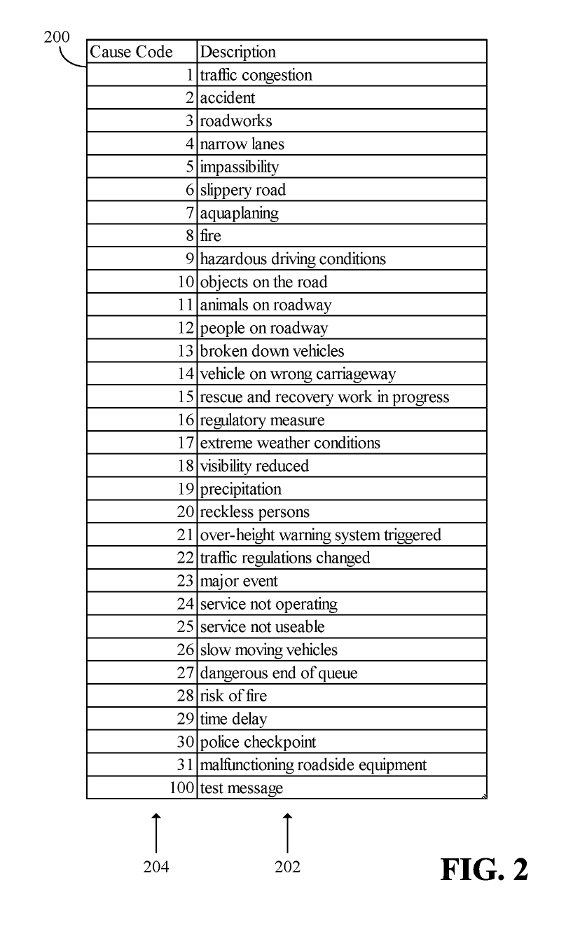

In operation, the navigation service 112 can receive event data 140 from one or more event data sources, and store the event data 140 to one or more functional data structures in real time, for example to one or more moving event data tables 142. For instance, the navigation service 112 can receive the event data 140 from one or more of the client devices 120-126, one or more physical sensors and/or virtual sensors that monitor traffic and events affecting travel on roadways, and/or one or more other systems. Examples of events represented by the event data 140 can include, but are not limited to, events indicated in ISO/TS 18234-9 (TPEG1-TEC Part 9), section 7.3.2. FIG. 2 illustrates a table 200 indicating examples of events 202 under the heading “Description” and corresponding cause codes 204 under the heading “Cause Code.”

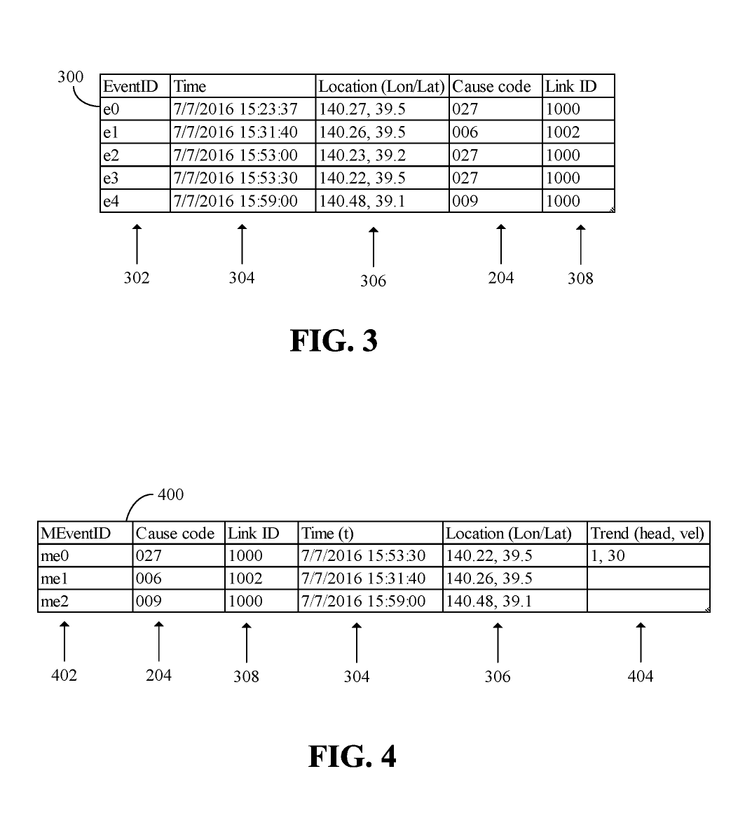

FIG. 3 illustrates a table 300 indicating examples of event data 140 received by the navigation service 112. The event data 140 can indicate the events using the cause codes 204. In addition, the event data 140 can include an event identifier 302 for each event, a time stamp 304 for each event (e.g., a time stamp indicating when the event was initially detected), a location 306 of each event (e.g., GPS coordinates, address(es), mile marker(s), etc.), a link identifier 308 for each event and, optionally, other data related to the events (not shown). The link identifier 308 can indicate a particular road map (e.g., digitized road map) and an area (e.g., road) in that map affected by the event. Examples of other data include, but are not limited to, data indicating a period of time an event is anticipated to continue, a time when an event is expected to conclude, a level of impact on traffic patterns due to an event, and so on.

FIG. 4 illustrates a table 400 indicating examples of event data stored to a functional data structure, for example the moving event data table 142, by the navigation service 112. The table 400 can include, for selected events, the cause code 204, the time stamp 304, the location data 306 and the link identifier 308 contained in the event data 140 for the events. The table 400 also can include, for the selected events, a moving event identifier 402. The moving event identifier 402 can be an identifier assigned to an event in the functional data structure. The table 400 also can include trend data 404 indicating a trend for the event, for example a heading and velocity at which the event is moving, a changing intensity of the moving event (e.g., increasing or decreasing recitation), etc. In illustration, if the same event is indicated in different event data 140 received at different times, the navigation service 112 can determine, from the locations indicated in the respective event data 140, a heading and velocity in which the event is moving. The table 400 optionally can include other data related to the selected events (not shown).

The event data stored to the functional data structure need not include all of the event data 140 that is received. Instead, the navigation service 112 can selectively choose which event data 140 to store, and selectively update the data contained in the functional data structure. For example, if the navigation service 112 receives event data 140 for a previously unreported event, the navigation service 112 can add that event data 140 to the moving event data table 142. If, however, the navigation service 112 receives event data 140 for a previously reported event, the navigation service 112 optionally can update the moving event data table 142 using the new event data 140.

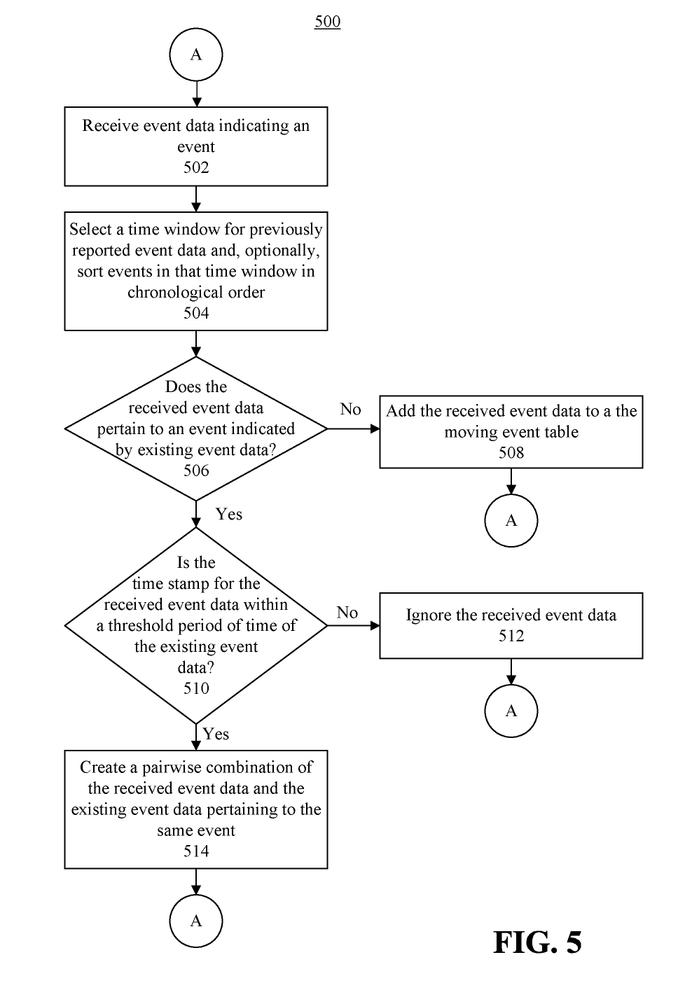

FIG. 5 is a flow chart illustrating an example of a method 500 of maintaining event data in a functional data structure, such as the moving event data table 142. At step 502, the navigation service 112 can receive event data 140 indicating an event. At step 504, the navigation service 112 can select a time window for previously reported event data 140 and, optionally, sort events in that time window in a chronological order.

At decision box 506, the navigation service 112 can determine whether the received event data 140 pertains to an event indicated by existing event data 140. For example, the navigation service 112 can determine whether the cause code 204 and link identifier 308 for the received event data 140 match the cause code 204 and link identifier 308 for existing event data. If so, the navigation service 112 can determine that the received event data 140 pertains to the same event indicated by the existing event data 140.

In a another arrangement, the navigation service 112 can determine whether the location 306 indicated in the received event data 140 is the same location 306 indicated by existing event data 140 having the same cause code 204 as the received event data 140. If so, the navigation service 112 can determine that the received event data 140 and existing event data 140 pertain to the same event. In yet another arrangement, the navigation service 112 can determine whether the location 306 indicated in the received event data 140 is on a same road and within a threshold distance from a location 306 indicated by existing event data 140 having the same cause code 204 as the received event data 140. If so, this can indicate that the received event data 140 and existing event data 140 pertain to the same event, though the event may have moved. Thus, the navigation service 112 can determine that the received event data 140 and the existing event data 140 pertain to the same event. The threshold distance can be determined based on the specific cause code 204. For example, the navigation service 112 can specify threshold distances for various events that may move, such as traffic congestion, roadworks, impassibility, fire, hazardous driving conditions, animals or people on a roadway, vehicle on a wrong carriageway, extreme weather conditions, visibility reduced, precipitation, reckless persons, slow moving vehicles, dangerous end of queue, risk of fire, time delay, and so on.

In illustration, if the received event data 140 indicates a cause code 204 for an accident, and the location 306 indicated by the received event data 140 is the same as a location 306 indicated by existing event data 140 having the same cause code 204, the navigation service 112 can determine that the received event data 140 pertains to the same accident indicated in the previous event data 140. If, however, the location 306 indicated by the received event data 140 is not the same as the location 306 indicated by the existing event data 140, the navigation service 112 can determine that the received event data 140 indicates a different accident than that indicated in the previous event data 140.

In another example, assume received event data 140 and existing event data both indicate a cause code 204 for traffic congestion. If the location 306 indicated by the received event data 140 is not the same as the location 306 indicated in the existing event data 140, but the respective locations 306 are within a threshold distance of each other, this can indicate that both the received event data 140 and existing event data 140 pertain to the same traffic congestion. Thus, the navigation service 112 can determine that the received event data 140 and the existing event data 140 pertain to the same event, even though that event may have moved over time.

If the received event data 140 does not pertain to an event indicated by the existing event data 140, at step 508 navigation service 112 can add the received event data to the moving event data table 142. If the received event data 140 does pertain to an event indicated by the existing event data 140, the process can proceed to decision box 510.

At decision box 510, the navigation service 112 can determine whether the time stamp for the received event data 140 is within a threshold period of time of the existing event data 140 pertaining to the same event (e.g., having the same cause code 204 and link identifier 308 as the received event data, etc.). If not, at step 512 the navigation service 112 can ignore the received event data 140. In another arrangement, the navigation service 112 can delete the existing event data 140 pertaining to the same event from the moving event data table 142 and add the received event data 140 to the moving event data table 142.

If the time stamp for the received event data 140 is within a threshold period of the existing event data 140 that pertains to the same event as the received event data 140, at step 514 the navigation service 112 can create a pairwise combination of the received event data 140 and the existing event data pertaining 140. For example, the navigation service 112 can update, in the moving event data table 142, a record for the existing event data 140. Such update can include updating the time stamp in the record to be the time stamp 304 indicated in the received event data 140, and updating the location data 306 indicated in the record to be the location indicated in the received event data 140. Further, based on the location 306 and time stamp 304 indicated in the existing event data 140 and the location 306 and time stamp 304 indicated in the received event data 140, the navigation service 112 can determine a trend 404 for the event, and add the determined trend 404 to the record. In illustration, if the received event data 140 indicates that the event has moved from the location indicated in the existing event data 140, the navigation service 112 can determine the movement based on the distance between the respective locations 306 and the differences between the respective time stamps 304, and indicate as the trend 404 the heading and velocity of the movement.

Regardless of whether the steps 508, 512, 514 while processing the received event data 140, the navigation service 112 can repeat the method 500 for each new event data 140 received. Moreover, the navigation service 112 can maintain a log of each event data 140, at least for a threshold period equaling the time window used for step 504, for purposes of performing the decision steps 506 and 510 in response to new event data 140 being received. The navigation service 112 can perform the processes described in method 500 in real time, for example as data is received by the navigation service 112.

Referring again to FIG. 1, the navigation service 112 can receive the historical trip pattern data 160 for each of a plurality of vehicles. The navigation service 112 can receive the historical trip pattern data 160 from the client devices 120-126, from one or more functional data structures (e.g., database tables) maintained by the navigation service 112, or from one or more other sources of such data. The historical trip pattern data 160 can include data relating to driving patters, for example routes traveled, turns made, speeds traveled along various roadways, time spent at various intersections, and so on.

The historical trip pattern data 160 for each vehicle can include historical trip data for the vehicle itself and/or historical trip data for a driver of the vehicle. For example, if the navigation service 112 has knowledge of a particular vehicle, but not the actual driver of the vehicle, the navigation service 112 can receive historical trip pattern data 160 for that vehicle as the historical trip pattern data 160. If, however, the navigation service 112 has knowledge of a particular driver driving a vehicle, the navigation service 112 can receive historical trip pattern data 160 for that driver as the historical trip pattern data 160 for the vehicle.

For example, if the historical trip pattern data 160 is based on GPS data provided by a navigation system integrated with the vehicle, but multiple people drive the vehicle, the historical trip pattern data 160 may not be based on any particular person's driving patterns. Instead, it can be based on the driving patterns of all of the people driving the vehicle. If, however, the navigation server 110 or the navigation system of the vehicle identifies each person driving the vehicle when the vehicle is driven, the historical trip pattern data 160 can be based on a particular person's driving patterns while driving that vehicle and/or the particular person's driving patterns while driving one or more other vehicles.

In another example, if the historical trip pattern data 160 is based on GPS data provided by a mobile device (e.g. smart phone or tablet computer) of a driver, the historical trip pattern data 160 may be based on that particular GPS data. Moreover, a driver may drive different vehicles. If the historical trip data is obtained from a mobile device of a driver, that historical trip data can be used as the historical trip pattern data 160 for any vehicle driven by that driver, regardless of whether the navigation server 110 has knowledge of the particular vehicle. In other words, the navigation server 110 can identify the vehicle based on a user identifier assigned to the driver of the vehicle or an identifier assigned to the driver's mobile device.

Based on the historical trip pattern data 160, the navigation service 112 can generate, for each currently active event, time-distance data arrays 150 for each vehicle (or driver). The time-distance data arrays 150 can indicate destinations to which each vehicle may travel, and amounts of time for the vehicle to travel various distances, for example between various locations, while traveling to such destinations. Further, the navigation service 112 can identify travel routes the vehicle may travel that may be affected by the event. For example, the time distance graphs can indicate, at different distances from the event, an average amount of time it would take each vehicle to reach the event starting from those distances. In illustration, the navigation service 112 can access a map of roadways covering an area within a threshold distance from the event. The navigation service 112 can, for each node roadway node (e.g., intersection), determine a route most commonly used by the vehicle to travel from that node to the event, and determine an average time it would take vehicle to travel from that node to the location of the event. When determining the average time, the navigation service 112 can process input parameters indicating average speeds driven by the vehicle (or by specific drivers of the vehicle) along roadways, average durations of time the vehicle is stopped at various intersection, traffic signals, etc. Further, when determining the average time, the navigation service 112 can also can factor in other events that may be located between the vehicle and the event for which the time-distance data arrays 150 are being generated.

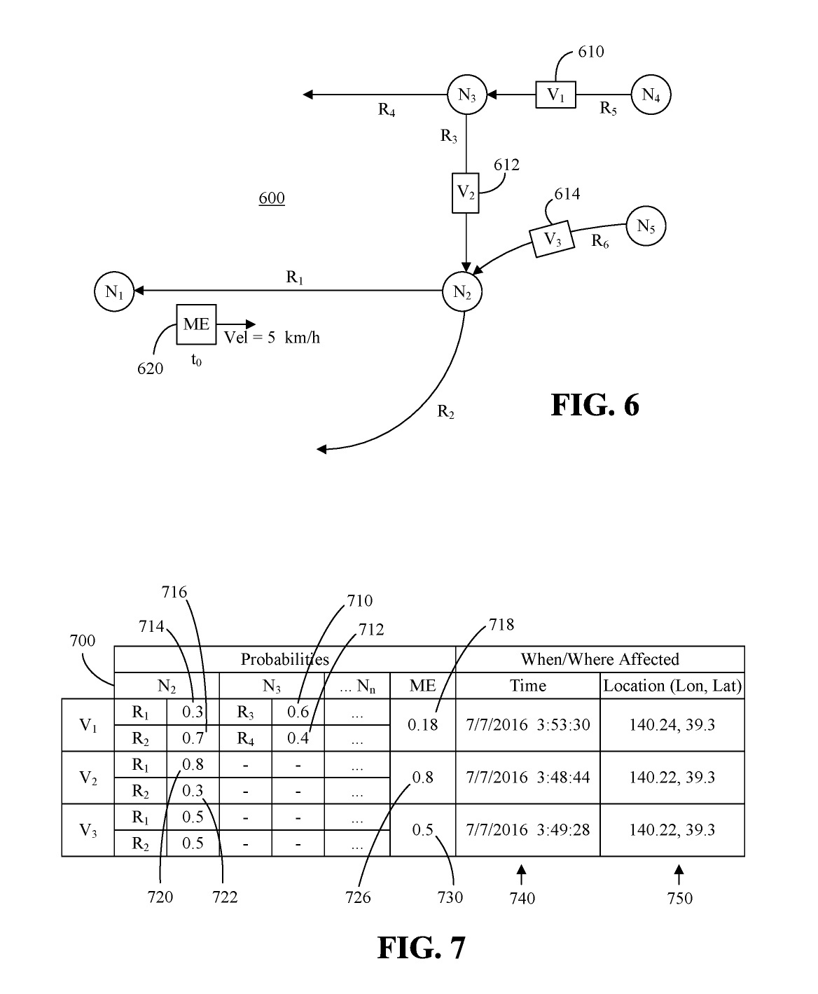

Based on the historical trip pattern data 160 and the time-distance data arrays 150, for each event the navigation service 112 can generate direction probability data 170 indicating, for each vehicle, a probability that the vehicle will be affected by the event, and when and/where the vehicle will be affected by the event, as illustrated in the following example described with reference to FIGS. 6 and 7. The direction probability data 170 for a particular vehicle can be based on driving patters of a particular driver of the vehicle or based on driving patterns of a plurality of drivers that drive the vehicle.

FIG. 6 is a diagram depicting an example of a road network 600, affected by an event, on which vehicles 610, 612, 614 are traveling. FIG. 7 illustrates a table 700 indicating examples of probabilities each vehicle 610, 612, 614 will be affected by an event, and when and where the vehicle will be affected.

Referring to FIG. 6, The road network 600 can include roads R₁, R₂, R₃, R₄, R₅, R₆ connected by nodes (e.g., intersections) N₁, N₂, N₃, N₄, N₅. In this example, assume that roads R₃ and R₆ merge at node N₂, and from roads R₃ and R₆, vehicles may proceed to road R₁ or road R₂. Also, assume that from road R₅, at node N₃ vehicles may proceed to road R₃ or road R₄. Further, assume that there is a moving event ME on road R₁, and the event is moving along road R₁ toward node N₂ at a velocity of 5 km/h.

The navigation service 112 can determine, at various nodes N₁-N₅ of road network, a probability that a particular vehicle will proceed onto a particular road R₁-R₅. Further, based on those probabilities, the navigation service 112 can determine a probability, for each vehicle 610, 612, 614, that the vehicle will travel on a road R₁ affected by an event 620, a time until the vehicle reaches the event 620, and a location where the vehicle reaches the event 620. In the case that the event is a moving event (i.e., moves over time), the location and time at which a vehicle reaches the event 620 will be interdependent.

For each vehicle 610, 612, 614, the navigation service 112 can analyze the historical trip pattern data 160 for that vehicle to determine probabilities that the vehicle will proceed onto particular roads R₁-R₅ at particular nodes N₁-N₅, and store the probability data in the table 700 of FIG. 7, or another suitable functional data structure. In illustration, while the vehicle 610 is traveling on road R₅ heading toward node N₃, the navigation service 112 can determine a probability 710 that at node N₃ the vehicle 610 will proceed onto road R₃ and a probability 712 that the vehicle 610 will proceed onto road R₄. Further, assuming the vehicle 610 will proceed onto road R₃, the navigation service 112 can determine a probability 714 that at node N₂ the vehicle 610 will proceed onto road R₁ and a probability 716 that the vehicle 610 will proceed onto road R₂. Because the moving event 620 affects road R₁, the vehicle 610 may be affected by the event 620 if the vehicle 610 proceeds onto road R₁. Thus, a probability 718 that the vehicle 610 will be affected by the event 620 can be determined by determining the probability that, from the current location of the vehicle 610, the vehicle will proceed onto road R₁. Accordingly, the navigation service 112 can determine the probability 718 based on the probabilities 710, 714, for example by multiplying the probability 714 by the probability 710.

In this example, the vehicle 612 currently is traveling on road R₃. The navigation service 112 can determine a probability 720 that at node N₂ the vehicle 612 will proceed onto road R₁ and a probability 722 that the vehicle 612 will proceed onto road R₂. Because the moving event 620 affects road R₁, the vehicle 612 may be affected by the event 620 if the vehicle 612 proceeds onto road R₁. Thus, a probability 726 that the vehicle 612 will be affected by the event 620 can be determined based on the probability that, from the current location of the vehicle 612, the vehicle will navigate onto road R₁. Accordingly, the navigation service 112 can determine the probability 726 based on the probability 720. For example, the navigation service 112 can set the probability 726 to be equal to the probability 720. A probability 730 that the vehicle 614 will be affected by the event 620 can be determined in a similar manner. The navigation service 112 can store the probabilities 710-730 as direction probability data 170 (FIG. 1).

At this point, it should be noted that the road network 600 is not limited to the above examples, and can include any number of nodes and roads. The navigation service 112 can determine probabilities for which roads vehicles may proceed for any number of nodes. Accordingly, the navigation service 112 can determine probabilities that vehicles will be affected by a moving event based on any number of such node probabilities.

As noted, the event 620 can be a moving event that moves over time. Using the time-distance data arrays 150 and the direction probability data 170, the navigation service 112 can simulate an effect of moving event 620 on each vehicle by generating moving event simulations 185 for each vehicle 610-614. For example, the navigation service 112 can include, or access, a moving event simulator 180 to generate the moving event simulations 185. The moving event simulations 185 can predict, for each vehicle 610-614, when and where the vehicle 610-614 will encounter the event 620, and the effect of the event 620 on the vehicle 610-614. Regarding the effect of the event 620, a moving event simulation 185 for a particular vehicle 610-614 can indicate a speed at which the vehicle 610-614 may travel while traveling through, or proximate to, the event 620, whether the vehicle 610-614 will be stopped for a threshold period of time due to the event 620, and/or how long it will take the vehicle 610-614 to travel through or past the event 620.

In illustration, the moving event simulator 180 can identify a current location of the event 620 and each of the vehicles 610-614. Using the time-distance data arrays 150, the moving event simulator 180 can determine respective speeds the vehicles 610-614 may travel along the respective roads R₁-R₅. Further, the moving event simulator 180 can, using the trend data 404 (FIG. 4), determine a heading and velocity of the event 620. At each of a plurality of sequential future time intervals, the moving event simulator 180 can predict a future location of each of the vehicles 610-614 and a future location of the event 620. For example, the moving event simulator 180 can perform such predictions for every 1 second, 5 seconds, 10 seconds, 30 seconds, 1 minute, 5 minutes, 10 minutes, and so on, from the current time. Based on the predictions, for each vehicle 610-614, the moving event simulator 180 can identify a time when, and a location where, the location of the vehicle 610-614 is expected to intersect with the location of the event 620, and thus be affected by the event, assuming the vehicle 610-614 proceeds onto road R₁ where the event 620 is located. Such times 740 and locations 750 for each vehicle 610-614 are indicated in table 700. The times 740 and locations 750 can be stored with direction probability data 170, or in another suitable functional data structure.

Each of the vehicles 610-614 may or may not proceed onto various roads R₁-R₆, as indicated by the probabilities 710-716 and 720-722, and a number of other vehicles 610-614 proceeding onto the roads R₁-R₆ may affect a time when a particular vehicle 610-614 intersects the event 620. The moving event simulator 180 can process the probabilities 710-716 and 720-722 for each vehicle 610-614 to determine a probability of a level of traffic on each of the roads R₁-R₆. The moving event simulator 180 can process such probabilities with the historical trip pattern data 160 for each respective vehicle 610-614 to simulate each vehicle's speed on the respective roads R₁-R₆ in view of a probable level of traffic, which can be based, at least in part, on the probabilities 710-716 and 720-722. Further, the moving event simulator 180 can process such probabilities to determine a probable contribution of other vehicles 610-614 to the event 620 (e.g., traffic congestion). Based on the probable contribution of other vehicles 610-614 to the event 620, the moving event simulator 180 can update the trend 404 (FIG. 4), and use the updated trend 404 to determine the times 740 and locations 750. For example, to determine the location of each of the respective vehicles 610-614 at each time interval, the moving event simulator 180 can determine traffic patterns of all vehicles. Determining such traffic patterns can include determining a probable speed of each of the respective vehicles 610-614 on each of the roads R₁-R₆ based on a probable number of other vehicles 310-314 on the same roads R₁-R₆, the historical trip pattern data 160 for each of the vehicles 310-314, and the trend 404 for the event 620.

In some cases, the event 620 may an event that does not move, for example a traffic accident. Nonetheless, the moving event simulator 180 can perform the above processes to determine the time 740 and location 750 data. In such cases there may not be trend data 404 for the event, and thus trend data 404 need not be considered by the moving event simulator 180 to determine the times 740 and location 750 when and where the vehicles 610-614 may be impacted by the event 620. In other cases, one event may trigger another event. For example, a first event can be a traffic accident, and a second event can be traffic congestion caused by the traffic accident. The moving event simulator 180 can perform the above processes to determine the time 740 and location 750 data for each of the vehicles 610-614 by analyzing both events and their impact on traffic patterns, for example as previously described.

Based on the probabilities 718, 726, 730, the navigation service 112 can determine, for each of the vehicles 610-614, whether such vehicles 610-614 are likely to be impacted by the event 620 (or multiple events). For example, the navigation service 112 can identify vehicles 610-614 for which a probability 718, 726, 730 of being affected by the event 620 exceeds a threshold value, and indicate such vehicles 610-614 in a functional data structure, for example an affected vehicles/drivers data table 190. Further, with the vehicle indications, the navigation service 112 can indicate the cause code(s) 204 of the event(s) and the respective probabilities 718, 726, 730 the vehicles 610-614 will be affected by the event(s).

Responsive to identifying each such vehicle 610-614 are likely to be impacted by the event 620 (or multiple events), the navigation service 112 can communicate a vehicle notification 195 to the client device 120-126 (e.g., a navigation system of the vehicle, a smart phone or tablet computer of a driver of the vehicle, etc.) associated with the respective vehicle 610-614. For example, the navigation service 112 can communicate the vehicle notification 195 to each vehicle 610-614 (or driver) for which the probability 718, 726, 230 that the vehicle 610-614 will be affected by the event 620 exceeds a threshold value (e.g., greater than 0.1, 0.2, 0.3, 0.4, 0.5 or 0.6). Each vehicle notification 195 can indicate the event(s) 620 triggering the notification 195, the time 740 when the vehicle 610-614 will be affected by the event(s) 620, and the location 750 where the vehicle 610-614 will be affected by the event(s) 620. Based on the vehicle notifications 195, respective drivers of the vehicles 610-614 may choose to travel on alternate routes to avoid the event(s) 620. If the drivers do not choose to do so, the drivers still can be notified as to the occurrence of the event(s) 620, and be prepared for any delays that may occur due to the event(s) 620.

In one non-limiting arrangement, for each vehicle 610-614, responsive to communicating a respective vehicle notification 195, the navigation service 112 can remove the vehicle 610-614 from the affected vehicles/drivers data table 190. Accordingly, the vehicle 610-614 need not receive additional notifications 195. In another arrangement, each of the affected vehicles 610-614 can receive additional notifications 195 at a periodic interval until the vehicles 610-614 intersect the event(s) 620 or are past the event(s) 620.

The navigation service 112 can iterated the above processes for a plurality of events. For example, the navigation service 112 can process data representing the effect of the event 620 on each vehicle 610-614 to update the time-distance data arrays 150. The navigation service 112 can use the updated time-distance data arrays 150 to simulate the effect of other events on the vehicles 610-614, for example other events located past the event 620, or other events which may affect the vehicles 610-614 if the vehicles travel from road R₁ onto another road via node N₁.

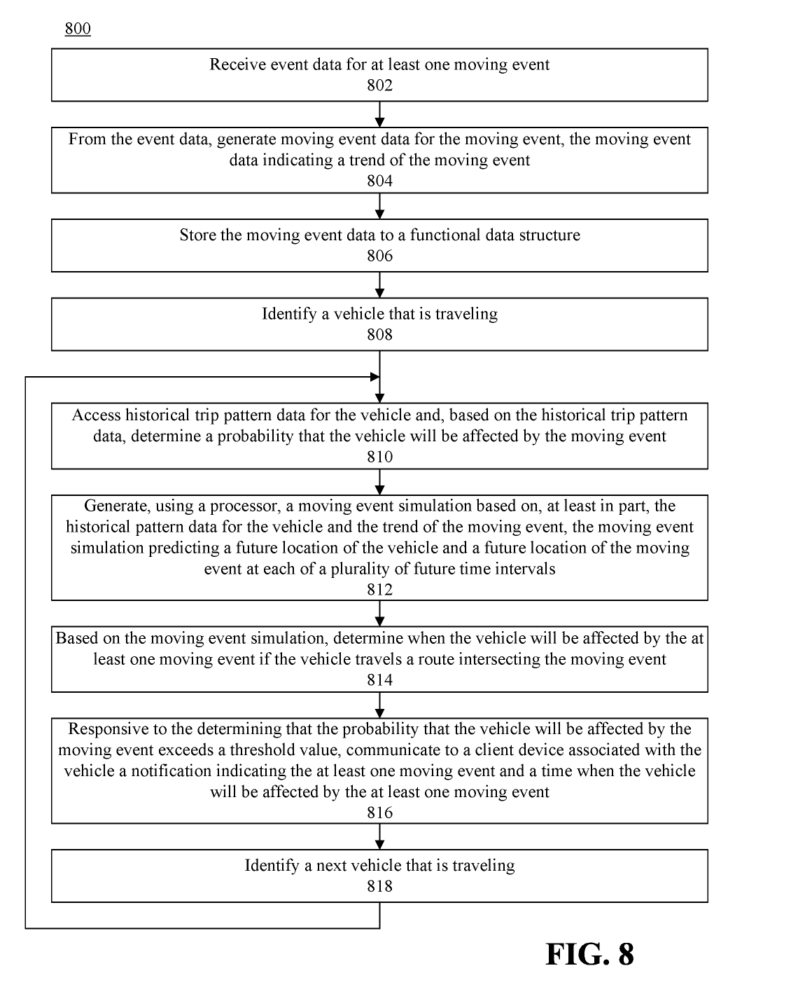

FIG. 8 is a flow chart illustrating an example of a method 800 of generating a moving event simulation to determine when a vehicle will be affected by a moving event. At step 802, the navigation service 112 can receive event data for at least one moving event. At step 804, the navigation service 112 can, from the event data, generate moving event data for the moving event, the moving event data indicating a trend of the moving event. By way of example, at step 804 the navigation service 112 can implement the method 500 of FIG. 5 to generate the moving event data. At step 806, the navigation service 112 can store the moving event data to a functional data structure, for example the moving event data table(s) 142.

At step 808, the navigation service 112 can identify a vehicle (or driver) that is traveling. At step 810, the navigation service 112 can access historical trip pattern data for the vehicle and, based on the historical trip pattern data, determine a probability that the vehicle will be affected by the moving event, for example as described.

At step 812, the navigation service 112 can generate, using a processor, a moving event simulation based on, at least in part, the historical pattern data for the vehicle and the trend of the moving event. The moving event simulation can predict a future location of the vehicle and a future location of the moving event at each of a plurality of future time intervals. By way of example, the navigation service 112 can process the historical trip pattern data to generate a time-distance data array for the vehicle. The historical trip pattern data can indicate amounts of time for the vehicle to travel various distances. The amounts of time for the vehicle to travel various distances can be based on, at least in part, at least one other event that is located between the vehicle and the moving event. The navigation service 112 can process the time-distance data array with the trend of the moving event to generate the moving event simulation.

At step 814, the navigation service 112 can, based on the moving event simulation, determine when the vehicle will be affected by the at least one moving event if the vehicle travels a route intersecting the moving event. The navigation service 112 also can, based on the moving event simulation, determine where the vehicle will be affected by the at least one moving event if the vehicle travels a route intersecting the moving event, for example where the vehicle will intersect with the moving event. At step 816, the navigation service 112 can, responsive to the determining that the probability that the vehicle will be affected by the moving event exceeds a threshold value, communicate to a client device associated with the vehicle (e.g., a navigation system of the vehicle, a smart phone or tablet computer of a driver of the vehicle, etc.) a notification indicating the at least one moving event and a time when the vehicle will be affected by the at least one moving event. Accordingly, the driver of the vehicle can choose whether to proceed on an alternate route based on the notification.

At step 818, the navigation service 112 can identify a next vehicle (or driver) that is traveling, and the navigation service 112 can repeat steps 810-816 for that vehicle. The process can iterate until the event has cleared. The navigation service 112 can perform the processes described in method 800 in real time, for example as the navigation service 112 continues to receive event data 140.

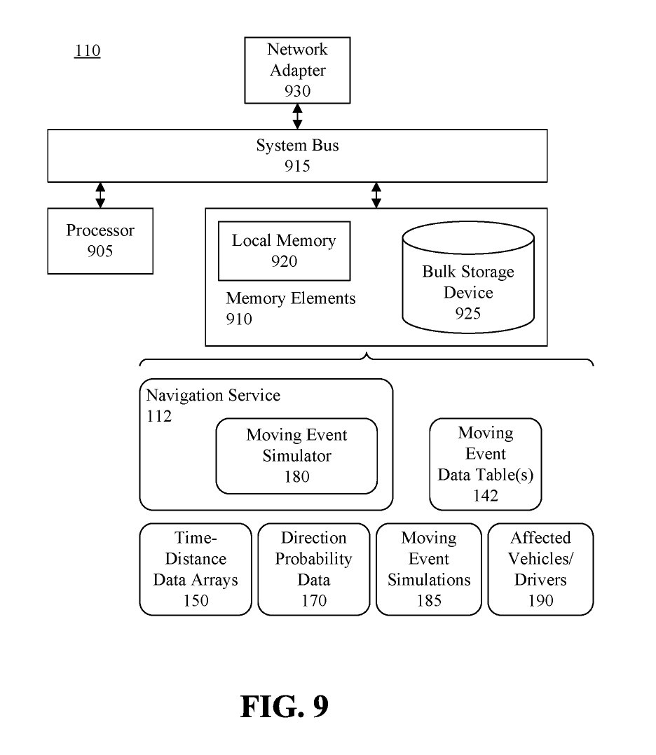

FIG. 9 is a block diagram illustrating example architecture for the navigation server 110. The navigation server 110 can include at least one processor 905 (e.g., a central processing unit) coupled to memory elements 910 through a system bus 915 or other suitable circuitry. As such, the navigation server 110 can store program code within the memory elements 910. The processor 905 can execute the program code accessed from the memory elements 910 via the system bus 915. It should be appreciated that the navigation server 110 can be implemented in the form of any system including a processor and memory that is capable of performing the functions and/or operations described within this specification. For example, the navigation server 110 can be implemented as a server, a plurality of communicatively linked servers, and so on.

The memory elements 910 can include one or more physical memory devices such as, for example, local memory 920 and one or more bulk storage devices 925. Local memory 920 refers to random access memory (RAM) or other non-persistent memory device(s) generally used during actual execution of the program code. The bulk storage device(s) 925 can be implemented as a hard disk drive (HDD), solid state drive (SSD), or other persistent data storage device. The navigation server 110 also can include one or more cache memories (not shown) that provide temporary storage of at least some program code in order to reduce the number of times program code must be retrieved from the bulk storage device 925 during execution.

One or more network adapters 930 can be coupled to navigation server 110 to enable the navigation server 110 to become coupled to client devices, other systems, computer systems, remote printers, and/or remote storage devices through intervening private or public networks. Modems, cable modems, transceivers, and Ethernet cards are examples of different types of network adapters 930 that can be used with the navigation server 110.

As pictured in FIG. 9, the memory elements 910 can store the components of the navigation server 110 of FIG. 1, namely the navigation service 112, the moving event simulator 180, the moving event data table(s) 142, the time-distance data arrays 150, the direction probability data 170, the moving event simulations 185 and data indicating the affected vehicles/drivers 190. Being implemented in the form of executable program code, the navigation service 112 and the moving event simulator 180 can be executed by the navigation server 110 and, as such, can be considered part of the navigation server 110. Moreover, the navigation service 112, the moving event simulator 180, the moving event data table(s) 142, the time-distance data arrays 150, the direction probability data 170, the moving event simulations 185 and data indicating the affected vehicles/drivers 190 are functional data structures that impart functionality when employed as part of the navigation server 110.

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” or similar language means that a particular feature, structure, or characteristic described in connection with the embodiment is included in at least one embodiment described within this disclosure. Thus, appearances of the phrases “in one embodiment,” “in an embodiment,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving event data for at least one moving event;
from the event data, generating moving event data for the moving event, the moving event data indicating a trend of the moving event;
storing the moving event data to a functional data structure;
for each of a plurality of vehicles:
accessing historical trip pattern data for the vehicle and, based on the historical trip pattern data, determining a probability that the vehicle will be affected by the moving event;
generating, using a processor, a moving event simulation based on, at least in part, the historical pattern data for the vehicle and the trend of the moving event, the moving event simulation predicting a future location of the vehicle and a future location of the moving event at each of a plurality of future time intervals;
based on the moving event simulation, determining when the vehicle will be affected by the at least one moving event if the vehicle travels a route intersecting the moving event; and
responsive to the determining that the probability that the vehicle will be affected by the moving event exceeds a threshold value, communicating to a client device associated with the vehicle a notification indicating the at least one moving event and a time when the vehicle will be affected by the at least one moving event.

2. The method of claim 1, wherein the historical pattern data for each vehicle is used to generate a time-distance data array for each vehicle and, for each vehicle, the time-distance data array is processed with the trend of the moving event to generate the moving event simulation.

3. The method of claim 2, wherein the time-distance data array indicates amounts of time for the vehicle to travel various distances.

4. The method of claim 3, wherein the amounts of time for the vehicle to travel various distances is based on, at least in part, at least one other event that is located between the vehicle and the moving event.

5. The method of claim 1, wherein generating moving event data for the moving event comprises:
determining whether a time stamp for the event data is within a threshold period of time of an existing event data; and
responsive to determining that the time stamp for the event data is within the threshold period of time of an existing event data pertaining to the moving event, creating a pairwise combination of the event data and the existing event data in the functional data structure.

6. The method of claim 1, wherein determining the probability that the vehicle will be affected by the moving event comprises determining, for each of a plurality of roads, a respective probability that the vehicle will proceed onto a particular one of the plurality of roads.

7. The method of claim 1, wherein the notification further indicates a location where the vehicle will be affected by the at least one moving event.

8. The method of claim 1, wherein the historical trip pattern data for the vehicle is historical trip pattern data for a driver of the vehicle.

9. A system, comprising:
a processor programmed to initiate executable operations comprising:
receiving event data for at least one moving event;
from the event data, generating moving event data for the moving event, the moving event data indicating a trend of the moving event;
storing the moving event data to a functional data structure;
for each of a plurality of vehicles:
accessing historical trip pattern data for the vehicle and, based on the historical trip pattern data, determining a probability that the vehicle will be affected by the moving event;
generating a moving event simulation based on, at least in part, the historical pattern data for the vehicle and the trend of the moving event, the moving event simulation predicting a future location of the vehicle and a future location of the moving event at each of a plurality of future time intervals;
based on the moving event simulation, determining when the vehicle will be affected by the at least one moving event if the vehicle travels a route intersecting the moving event; and
responsive to the determining that the probability that the vehicle will be affected by the moving event exceeds a threshold value, communicating to a client device associated with the vehicle a notification indicating the at least one moving event and a time when the vehicle will be affected by the at least one moving event.

10. The system of claim 9, wherein the historical pattern data for each vehicle is used to generate a time-distance data array for each vehicle and, for each vehicle, the time-distance data array is processed with the trend of the moving event to generate the moving event simulation.

11. The system of claim 10, wherein the time-distance data array indicates amounts of time for the vehicle to travel various distances.

12. The system of claim 11, wherein the amounts of time for the vehicle to travel various distances is based on, at least in part, at least one other event that is located between the vehicle and the moving event.

13. The system of claim 9, wherein generating moving event data for the moving event comprises:
determining whether a time stamp for the event data is within a threshold period of time of an existing event data; and
responsive to determining that the time stamp for the event data is within the threshold period of time of an existing event data pertaining to the moving event, creating a pairwise combination of the event data and the existing event data in the functional data structure.

14. The system of claim 9, wherein determining the probability that the vehicle will be affected by the moving event comprises determining, for each of a plurality of roads, a respective probability that the vehicle will proceed onto a particular one of the plurality of roads.

15. The system of claim 9, wherein the notification further indicates a location where the vehicle will be affected by the at least one moving event.

16. The system of claim 9, wherein the historical trip pattern data for the vehicle is historical trip pattern data for a driver of the vehicle.

17. A computer program product comprising a computer readable storage medium having program code stored thereon, the program code executable by a processor to perform a method comprising:
receiving, by the processor, event data for at least one moving event;
from the event data, generating, by the processor, moving event data for the moving event, the moving event data indicating a trend of the moving event;
storing, by the processor, the moving event data to a functional data structure;
for each of a plurality of vehicles:
accessing, by the processor, historical trip pattern data for the vehicle and, based on the historical trip pattern data, determining a probability that the vehicle will be affected by the moving event;
generating, by the processor, a moving event simulation based on, at least in part, the historical pattern data for the vehicle and the trend of the moving event, the moving event simulation predicting a future location of the vehicle and a future location of the moving event at each of a plurality of future time intervals;
based on the moving event simulation, determining, by the processor, when the vehicle will be affected by the at least one moving event if the vehicle travels a route intersecting the moving event; and
responsive to the determining that the probability that the vehicle will be affected by the moving event exceeds a threshold value, communicating, by the processor, to a client device associated with the vehicle a notification indicating the at least one moving event and a time when the vehicle will be affected by the at least one moving event.

18. The computer program product of claim 17, wherein the historical pattern data for each vehicle is used to generate a time-distance data array for each vehicle and, for each vehicle, the time-distance data array is processed with the trend of the moving event to generate the moving event simulation.

19. The computer program product of claim 18, wherein the time-distance data array indicates amounts of time for the vehicle to travel various distances.

20. The computer program product of claim 19, wherein the amounts of time for the vehicle to travel various distances is based on, at least in part, at least one other event that is located between the vehicle and the moving event.

21. The computer program product of claim 17, wherein generating moving event data for the moving event comprises:
determining whether a time stamp for the event data is within a threshold period of time of an existing event data; and
responsive to determining that the time stamp for the event data is within the threshold period of time of an existing event data pertaining to the moving event, creating a pairwise combination of the event data and the existing event data in the functional data structure.

22. The computer program product of claim 17, wherein determining the probability that the vehicle will be affected by the moving event comprises determining, for each of a plurality of roads, a respective probability that the vehicle will proceed onto a particular one of the plurality of roads.

23. The computer program product of claim 17, wherein the notification further indicates a location where the vehicle will be affected by the at least one moving event.

24. The computer program product of claim 17, wherein the historical trip pattern data for the vehicle is historical trip pattern data for a driver of the vehicle.
